(19) United States
(12) Patent Application Publication
(10) Pub. No.: US 2008/0228998 A1
(43) Pub. Date: Sep. 18, 2008

(54) MEMORY STORAGE VIA AN INTERNAL COMPRESSION ALGORITHM

(75) Inventors: Roberto Colecchia, San Jose, CA (US); Gabriele Sartori, Fremont, CA (US)

Correspondence Address: AMIN, TUROCY & CALVIN, LLP, 1900 EAST NINTH STREET, 24TH FLOOR, NATIONAL CITY CENTER, CLEVELAND, OH, 44114, US

(73) Assignee: SPANSION LLC, Sunnyvale, CA (US)

(21) Appl. No.: 11/687,479

(22) Filed: Mar. 16, 2007

(51) Int. Cl. G06F 12/00

(52) U.S. Cl. 711/103

(57) ABSTRACT

The subject specification discloses flash memory device with the capability of performing both internal compression as well as internal de-compression. Each of these actions takes place through appropriate algorithms. In normal operation, the compression occurs prior to a writing of data in a flash memory device. The compressed data travels to a storage location. The de-compression occurs after the reading of stored data and de-compressed data travels to an external system.

### TECHNICAL FIELD

The subject specification relates generally to flash memory devices and in particular to memory compression.

### BACKGROUND

The current economic market has a number of memory formats available for purchase. Random access memory (RAM) and read-only memory (ROM) are two of the most common memory formats available, and both are found in many electronic devices, for example for example personal computers. Two major differences exist between RAM and ROM memory. ROM can be written to only once, meaning that the information stored is practically guaranteed to remain saved. In addition, ROM does not require a constant source of power to retain its memory, meaning it is a non-volatile memory type. These characteristic of ROM are in direct contrast to characteristics of RAM which can be written to multiple times, allowing for greater range of usage since information that is no longer needed can be deleted. RAM is a volatile memory type, meaning it loses memory when no longer connected to a constant source of power. Computer systems can generally read from both of these memory types.

For most portable consumer applications, ROM and RAM are not ideal memory types. ROM memory devices can only be written to once; such that, each time user stores information, the user must obtain a new memory device. RAM could be a reasonable alternative because it can be written to multiple times; however, it requires a constant source of power, which also can be problematic. A user would need to constantly keep the RAM memory device plugged into an electrical outlet, thus greatly limiting portability, or keep the RAM on a constant supply of impractical and expensive battery power. ROM and RAM each provide benefits and problems for consumer usage. Flash memory capitalizes on benefits of RAM and ROM and minimizes problems already noted.

Flash memory devices are a popular means for storing information. They are small, lightweight, and have a relatively low manufacturing cost, which ultimately decreases consumer costs. These devices are removable, and can be placed into numerous consumer products, including cellular telephones and personal digital assistants. Some of the technological benefits are that the memory format is readable, re-writable, and non-volatile. This allows a user to re-use the device and transport without a constant source of power.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

The subject specification relates to writing information into a flash memory array. A typical flash memory device has an internal SRAM buffer, commonly referred to as a page buffer, and an internal non-volatile memory (NVM) array. In standard operation, a host system (e.g., a cellular telephone) loads information to the page buffer. The page buffer usually has a pre-determined memory capacity (e.g., currently ranging from about 2 Kilobytes to about 4 Kilobytes). The page buffer transfers the information to the NVM array for storage.

The subject specification approaches memory writing in a more detailed manner. The information loaded in the page buffer is compressed where typically, a loss-less data compressing algorithm performs the compression. Once compressed, the information travels to the NVM array for storage. The compression allows for storing larger amounts of information because information stored in a page buffer fits into less then the corresponding memory space of NVM array. A data compression engine typically carries out the compression, wherein the data compression engine is located in a logic circuit. The data compressing algorithms is typically a non-proprietary algorithm, for example for example a “.ZIP” format. While the subject specification applies to any suitable type information, greater compression gains are typically achieved with information that is not already compressed, for example for example executable code.

The subject specification also discloses reading compressed information. A host gives an address of a page for reading to a flash memory device. The flash memory device finds the page in memory, which is commonly in compressed format. This is generally accomplished by matching an external host page address with an internal address in a reference table or internal File Allocation Table (FAT). The flash memory device transfers the compressed page from the memory to a SRAM scratch pad buffer. An algorithm de-compresses data stored in the page and stores the data in an SRAM page buffer. Finally, the data travels from the SRAM page buffer to the host, for example a cellular telephone or personal digital assistant.

In addition, the subject specification discloses management of memory. For improved performance, a host address mapping should extend beyond the physical number of bits available in a memory array. For example, with an average compression of 50%, a 2-Gigabyte (GB) memory array maps from the host site as 4 GB of address space. The subject specification employs virtual bad blocks, which are blocks that cannot store information but they map into good blocks. There are two different kinds of virtual bad block allocation used, initial and dynamic. In initial virtual bad block allocation, an address space is set to equal a memory array space; whereas, dynamic virtual bad block allocation set an address space to be greater then a memory array space. These virtual bad blocks exist logically and not physically.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative flash memory device in accordance with an aspect of the subject specification.

FIG. 2 illustrates a representative flash memory device integrated with a compression check component in accordance with an aspect of the subject specification.

FIG. 3 illustrates a representative flash memory device integrated with an optimization component in accordance with an aspect of the subject specification.

FIG. 4 illustrates a representative look-up table utilized by an optimization component in accordance with an aspect of the subject specification.

FIG. 5 illustrates a representative flash memory device integrated with an aging component in accordance with an aspect of the subject specification.

FIG. 6 illustrates a representative flash memory device integrated with an authorization component in accordance with an aspect of the subject specification.

FIG. 7 illustrates a representative flash memory device integrated with a security component in accordance with an aspect of the subject specification.

FIG. 8 illustrates a representative flash memory device integrated with a notification component in accordance with an aspect of the subject specification.

FIG. 9a illustrates a representative flash memory device integrated with a mapping component in accordance with an aspect of the subject specification.

FIG. 9b illustrates a representative block diagram of virtual bad block mapping in accordance with an aspect of the subject specification.

FIG. 10a illustrates a representative flash memory device integrated with a locating component and a register component in accordance with an aspect of the subject specification.

FIG. 10b illustrates a representative table disclosing information produced and utilized by various aspects of the subject specification.

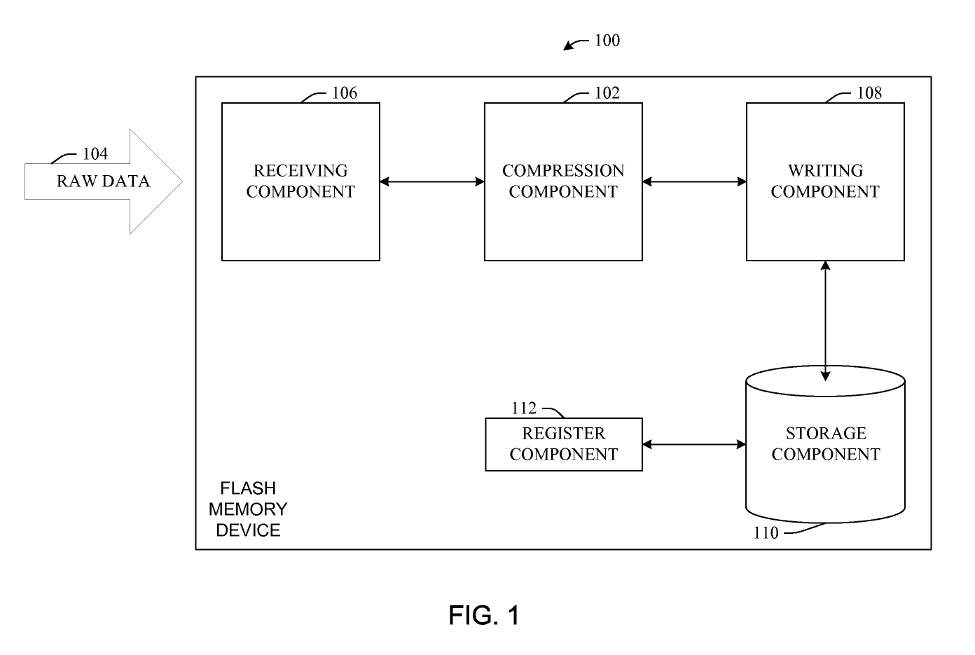

FIG. 1 illustrates a representative flash memory device in accordance with an aspect of the subject specification.

FIG. 12 illustrates a representative flash memory device integrated with a security component in accordance with an aspect of the subject specification.

FIG. 13 illustrates a representative flash memory device integrated with an authorization component in accordance with an aspect of the subject specification.

FIG. 14 illustrates a representative flash memory device in accordance with an aspect of the subject specification.

FIG. 15 illustrates a representative methodology of data compression in accordance with an aspect of the subject specification.

FIG. 16 illustrates a representative methodology of data de-compression in accordance with an aspect of the subject specification.

FIG. 17 illustrates a representative methodology of data de-compression and transfer in accordance with an aspect of the subject specification.

FIG. 18a illustrates a first part of a representative methodology of writing data to a flash memory device in accordance with an aspect of the subject specification.

FIG. 18b illustrates a second part of a representative methodology of writing data to a flash memory device in accordance with an aspect of the subject specification.

FIG. 18c illustrates a third part of a representative methodology of writing data to a flash memory device in accordance with an aspect of the subject specification.

FIG. 18d illustrates a fourth part of a representative methodology of writing data to a flash memory device in accordance with an aspect of the subject specification.

FIG. 19a illustrates a first part of a representative methodology of reading data from a flash memory device in accordance with an aspect of the subject specification.

FIG. 19b illustrates a second part of a representative methodology of reading data from a flash memory device in accordance with an aspect of the subject specification.

FIG. 20 illustrates a representative results table for file types in accordance with an aspect of the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter. As utilized herein, the terms “information”, “data”, and the like are to be used interchangeably.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

FIG. 1 is an example flash memory device 100 implemented with a compression component 102 that enables compressing of information 104. In addition to the compression component 102, the flash memory device 100 also has receiving and writing components 106 and 108 respectively, which receive inputted information in the form of raw data 104, and write the compressed data into a storage component 110 respectively. In this embodiment, all components are contained directly within the flash memory device 100.

In usual operation, data 104 travels to the flash memory device 100 from a host system, for example a cellular telephone or personal digital assistant. A user can initiate the transfer of a specific file, for example a photograph in ‘jpg’ format, from the host personal digital assistant to a flash memory device 100. Furthermore, a person can create an automated system, for example file back up, wherein the host system transfers a raw data 104 file automatically at a specific point in a time cycle. The final destination for raw data 104 from the host system is a receiving component 106.

The receiving component 106 can be an array of structures. For example, a flash memory device 100 can be configured with a universal serial bus (USB) plug, wherein the USB plug functions as the receiving component 106. This plug connects into a USB port located on the host system, a common feature on many personal electronic devices.

Raw data 104 received travels from the receiving component 106 to a compression component 102, where the compression component 102 takes the raw data 104 and compresses it. This process is useful because it allows raw data 104 to be stored in a smaller location. For example, 1-Gigabyte (GB) of raw data could be compressed and reduced to 700-Megabytes (MB) because of this compression component 102. Often times, the compression takes place with a loss-less compression algorithm; however, a compression component 102 could use other compression algorithm types, including a lossy compression format.

A loss-less compression algorithm is an algorithm that allows for an exact re-compression of compressed data. The difference between a loss-less algorithm and a lossy algorithm is the loss-less compression allows data to return to its original state while lossy compression only allows the data to return to a near original state. The compression algorithm can be either a proprietary or a non-proprietary algorithm. This compression can take place even if the host system has already compressed the data. For example, a host system can send a ‘.ZIP’ file to a flash memory device 100, wherein the original data is 1 GB and the .ZIP-compressed data is 667 MB. The compression component 102 can further compress the data down in size, even if it is a small amount, for example down to a size of 650 MB. The compressed data travels to a writing component 108.

The writing component 108 stores the compressed information into a storage component 110. One problem that can occur in a standard flash memory device 100 is the device 100 has no way of determining that there is compressed data stored in the storage component 110. For example, if the host system sent 1 GB of data 104, and the compression component 102 compressed it down to 700 MB; the system does not recognize that there is 700 MB and registers that there is 1 GB. To alleviate this problem, the storage component 110 typically contains a registry capable of holding information about compressed data. Each time memory is written to the storage component 110, the writing component 108 updates the registry so that the registry accurately reflects memory allocation in the storage component 110 as well as the type of compression algorithm was applied to each stored file.

It is possible for there to be a register component 112 to assist in operation of the flash memory device 100. The register component 112 is accessible from a host device through a special command. In common operation, the register component 112 communicates directly with a host device. The register component 112 contains information relating to the amount of space available in the storage component 110. The initial setting for the register component 112 is ‘all memory available’. When data is written to the storage component 110, the register component 112 is updated. A free space amount is decreased by the size of the information just written to the storage component 110.

For example, if there is a device with 4-gigabit (4 Gbit) of storage in a storage component. The available storage in the storage component ranges from ‘00000H’ to ‘FFFFFFFH’. An initial register value for the register component is set to ‘FFFFFFFH’, which is equal to 4 Gbit. If 1 Gbit of compressed information is written to the storage component, then the register value changes to ‘BFFFFFFH’, which is equal to 3 Gbit. A host device can read the register component and determine how much space is available in the device.

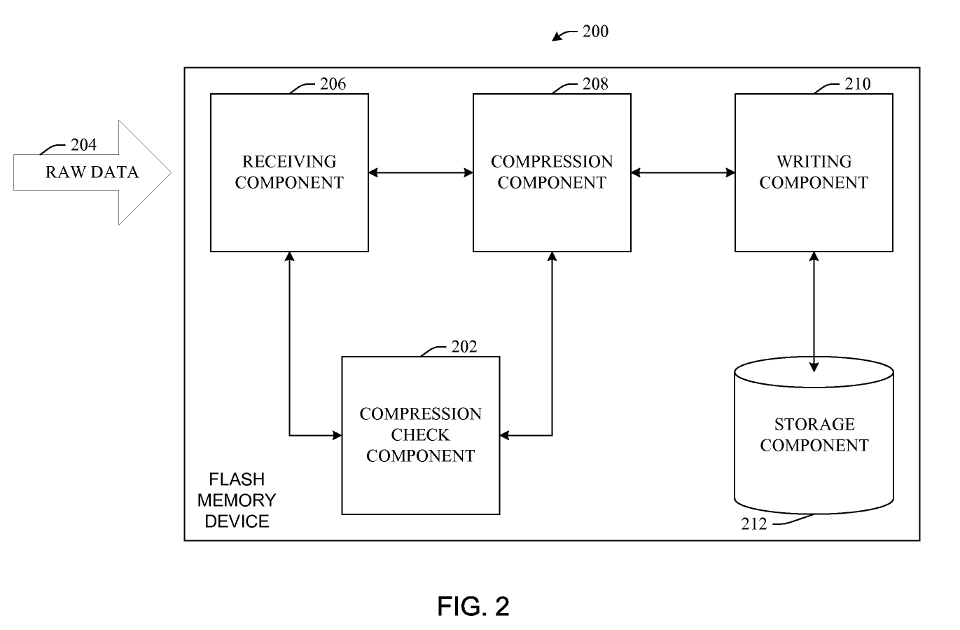

FIG. 2 illustrates an example flash memory device 200 implemented with a compression check component 202. Raw data 204 enters a receiving component 206 that communicates this raw data 204 to the check compression component 202. The compression check component 202 performs a check to determine if the raw data 204 is already in a compressed format prior to arriving at a compression component 208. For example, the raw data can be compressed in an array of different formats, for example ‘.dar’ format.

The compression check component 202 can operate in numerous different ways. One manner in which the compression check component 202 can operate is checking if the data is compressed. The answer to the question ‘is the data compressed?’ is stored in the registry in a writing component 210 so the system knows the inputted data size as well as if the data entered the flash memory device in a compressed format. In another operation, the compression check component 202 can bypass the compression stage if the information is already compressed. If the information is not compressed, then it is transferred to the compression component 208 for further compression before being written to a storage component 212.

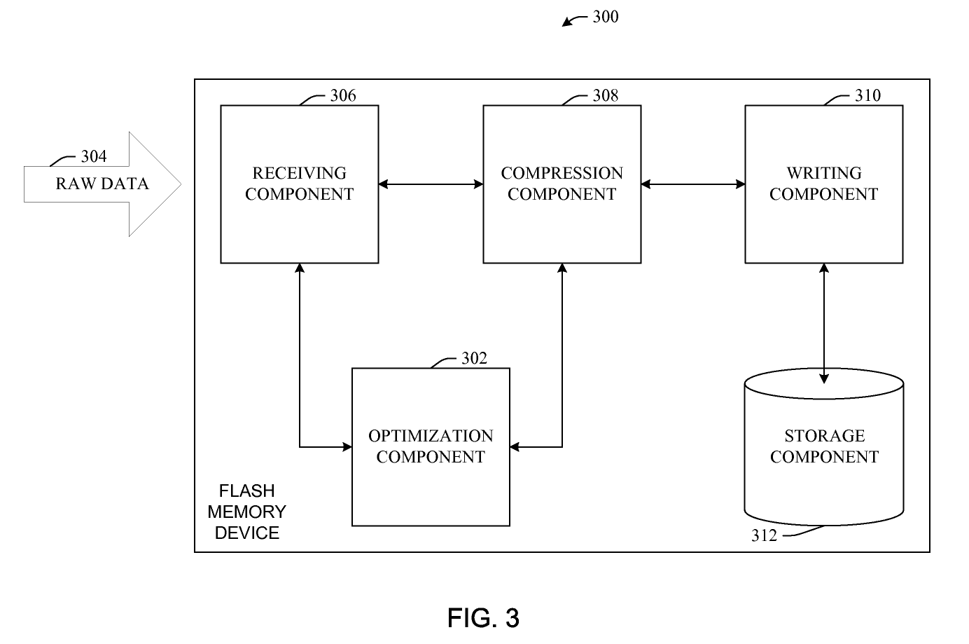

FIG. 3 illustrates an example flash memory device 300 implemented with an optimization component 302. Raw data 304 enters a receiving component 306. The receiving component 306 can then communicate the data to the optimization component 302. The optimization component 302 allows for the best data compression or at least one of the best data compressions to be applied to the raw data. The optimization component tells a compression component 308 which compression algorithm to run on the raw data 304. The data then travels to the compression component 308 where data compression takes place. Following compression, the data travels to a writing component 310 where the writing component 310 stores compressed information in a storage component 312.

The optimization component 302 typically contains a look-up table. The flash memory device can have a design with a plurality of stored compression formats. Each stored compression format can relate with at least one received compression format in a look-up table. This look-up table can be pre-determined at manufacturing or can be configured and modified by a host system. Each time the receiving component 306 receives new data 304; the optimization component 302 looks to the table and finds the optimal compression algorithm. The data then travels to the compression component 308 and the compression component applies the determined algorithm.

Another way of configuring an optimization component 302 is by implementing a trial-and-error system. The optimization component 302 can run short tests on the raw data 304, wherein the tests determine the amount of saved data that will occur by the running each compression algorithm. The results of the tests show which algorithm saves the most space. The optimization component 302 instructs the compression component 308 which compression algorithm to run.

There can also be a combination of the two previous configurations. The optimization component 302 can run a trial-and error system. After each trial-and-error run, a line is added to a look-up table. For example, raw data 304 enters the flash memory device 300 in ‘.zip’ format. The optimization component 302 runs a trial-and-error and it determines that algorithm X saves the most space (X is a representative variable for a file format and not a specific file format). The optimization table adds a link to the look-up table that algorithm X is the best with ‘.zip’ format. Therefore, any time the receiving component 306 receives information in ‘.zip’ format the optimization component 302 instructs the compression component 308 to run algorithm X. It is a waste of resources to run the trial-and-error again on ‘.zip’ since the optimization component 302 ran once for that format and the component knows the best format.

In a further embodiment, their can be a mixture of a look-up table and a trial-and-error configuration. As computers develop, it is likely that there is development of new compression formats. When a flash memory device 300 is manufactured, it can be in use for many years. Over the years of usage, new formats are developed that are not stored in the look-up table since they were not known at the time of manufacture. Therefore, there can be a look-up table for some or all formats known at the time of manufacture. If the receiving component 306 receives information in a known format, then the optimization component 302 relies on the look-up table. If the receiving component 306 receives information in an unknown format, then the optimization component 302 runs a trial-and-error sequence to find an optimal format. This result can be stored in the look-up table and the next time the receiving component receives raw data 304 in the new format, the look-up table has a corresponding entry.

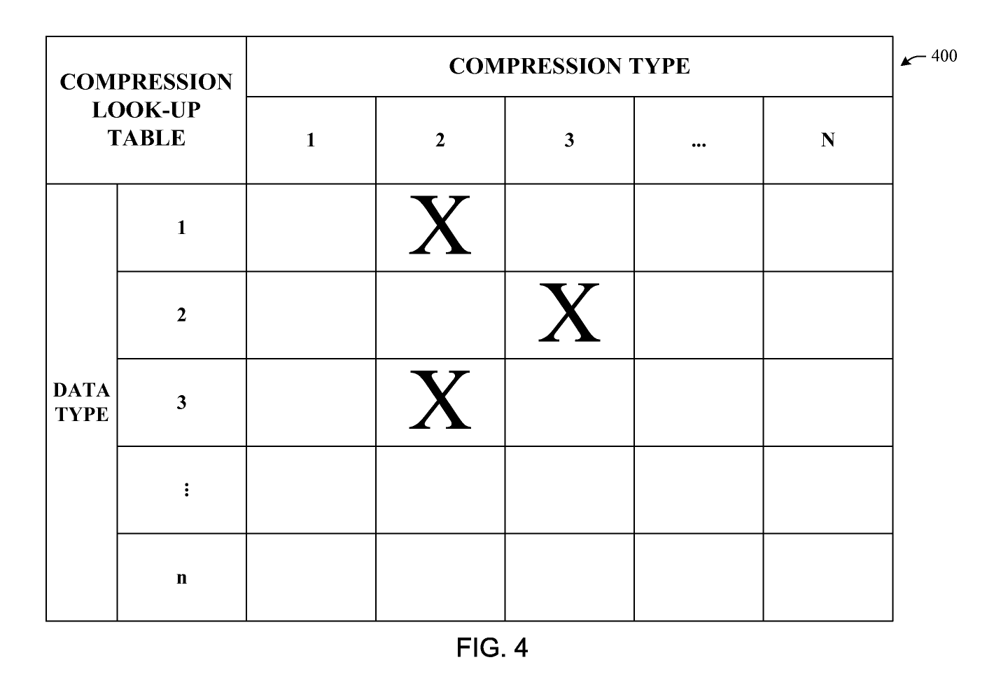

FIG. 4 illustrates an example of a look-up table 400 utilized by an optimization component. Data types are along the y-axis and range from 1-n and compression types are along the x-axis and range from 1-N. The data-types match each other, meaning that ‘1’ in the compression type column is the same compression a ‘1’ in the data type row. For example, ‘1’ can represent uncompressed data. At manufacturing, there was creation of a look-up table 400 and the table 400 cannot change. No data type would be optimal in uncompressed format, so no data type selects ‘1’ as the compression type. In the give table 400, format ‘2’ is optimal, so an optimization component selects format ‘2’ and instructs a compression component to run an algorithm that applies compression type ‘2’.

Data-type ‘2’ would likely not run best on its' own compression type since the data most often can be made smaller with another compression format. Therefore, compression type ‘3’ can make the raw data the smallest. Therefore, the optimization component instructs the compression component to run an algorithm applying compression type ‘3’. If there were no better format then compression type ‘2’ for data type ‘2’, then the operation component could instruct the compression component to not run an algorithm and directly pass the data to a writing component.

Data type ‘3’ would likely not run best on its own format. However, it is possible that compression type ‘2’ would work best for data type ‘3’ as well as data type ‘1’. Therefore, the optimization component instructs the compression algorithm to run the algorithm applying compression type ‘2’. The data type and compression type end in the variable format types ‘n’ and ‘N’ respectively. In most cases, there will be more data types then compression types. This is because the flash memory device has limited capacity as opposed to most host devices and data types are commonly developed after the programming of compression algorithms in a flash memory device. However, it is possible that the number of data types to be equal to the number of compression types or the data types to be less then the number of compression types.

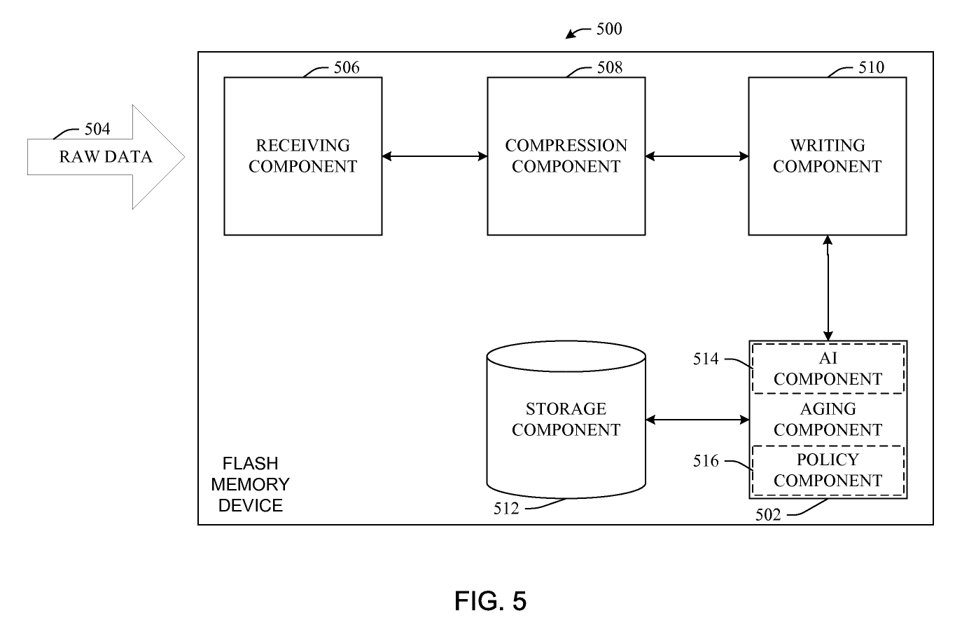

FIG. 5 illustrates an example flash memory device 500 implemented with an aging component 502. Raw data 504 enters the flash memory device into a receiving component 506. The receiving component 506 transfers the data 504 for compression at a compression component 508. Compressed information transfers to a writing component 510. In the displayed configuration, the writing component 510 sends information through an aging component 502 before writing the information to a storage component 512. The aging component 502 performs storage management, determining if any specific files should be overwritten in the storage component. This can apply to situations where the storage component is full or when there is space available.

Two common components in an aging component 502 are an artificial intelligence (AI) component 514 and a policy component 516. While the drawing shows both of these components 514, 516, one component can operate in the absence of the other and the aging component 502 can operate without either component (e.g., the aging component can check externally to a host device or a network device as to what to erase). Both of these components 514, 516 function to determine if newly written compressed data should overwrite currently stored information. An AI component 514 automatically deletes information based on pre-programmed conditions. For example, if a file in saved in storage location 512 has not been accessed over a specific period (e.g., six months), then the writing component 510 writes the compressed information to over non-accessed information in the storage component 512. This can occur at all times or only at times when the memory is full. The AI component 514 can also be configured with a logic sequence that determines which storage location to write to if there are multiple locations that have not been accessed over the specific period. For example, the AI component 514 can select the storage location with the longest time since access or the AI component 514 can select the storage location with the size nearest to the size of the compressed information.

The policy component 516 operates similar to the AI component 514, except a user on a host system performs the programming of a policy component 516. The user implements a number of rules on which the policy component 516 functions. For example, a user can make a rule that a writing component 510 writes over a ‘.zip’ file if there has been no access in nine months, but the writing component 510 writes over all other file types if there has been no access in six months. There can also be configuration of a policy component 516 where there is user interaction. For example, the policy component 516 can check if there are any files where there has been no access in twelve months. If there are files that have not been accessed over this period, then the policy component 516 sends a message to a user providing the option to overwrite the information. The user can have numerous options, for example selecting overwrites, canceling the writing of new information, or managing the storage (e.g., opening a folder of the storage and selectively deleting material).

There are alternate configurations with an aging component 502 that would also be appropriate. For example, the writing component 510 can directly connect to both the aging component 502 as well as the storage component 512. The aging component 502 can also connect with the storage component 512. The writing component 510 can access the aging component 502, wherein the aging component 502 accesses the storage component 512. In another alternative configuration, the writing component 510 can update a registry in the aging component 502. This eliminates a need for a direct connection between the aging component 502 and the storage component 512 since the again component 502 has a memory that contains information pertaining to a storage location.

In a further embodiment, the aging component 502 can be disabled; this can take place with an AI component and/or with a policy component. This would be useful when there is rarely accessing of stored information. For example, there can be information relating to a safe deposit box in a bank vault. Safe deposit boxes can go long lengths of time before being accessed (e.g., fifty years). One way of practicing this embodiment is having a user instructed disabling. In this practice, the raw data 504 can include data that instructs the aging component 502 not to function. When the data is stored in the storage component 512 and the aging component attempts to erase the data, the aging component can read that the information is not to be erased. Another way of practicing this embodiment is the aging component 502 having the ability to identify information that the aging component 502 should not erase. For example, the aging component 502 can determine that certain information being stored is data that should not be erased without an explicit command to erase. In a further manner of practicing the embodiment, the embodiment can function to disable the aging component 502, which can take place automatically or manually; in yet a further embodiment, the aging component can be reinstated.

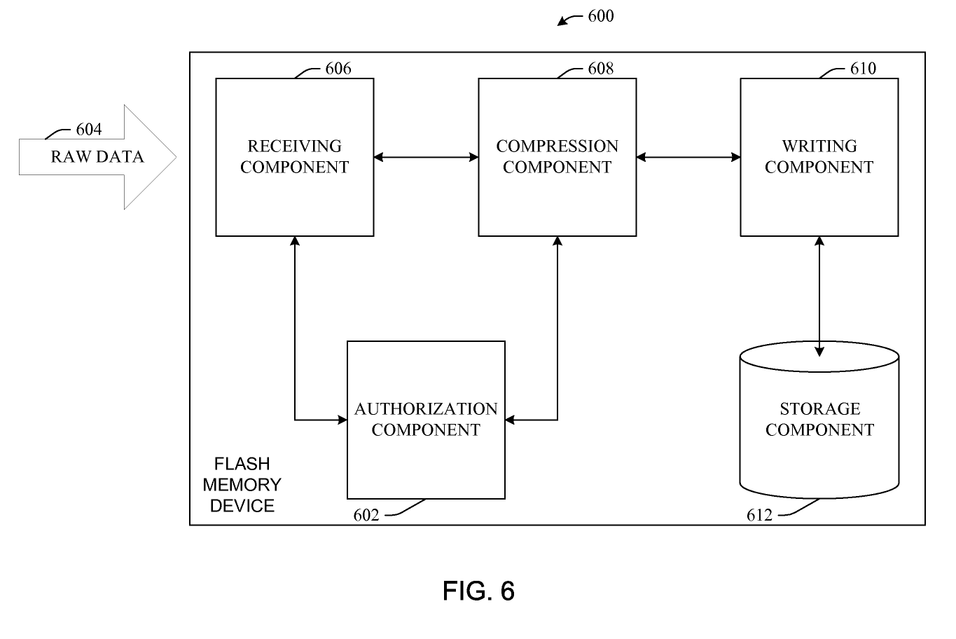

FIG. 6 illustrates an example flash memory device 600 implemented with an authorization component 602. A host system sends raw information 604 to a receiving component 606 that receives the information. The receiving component 606 then performs a check with an authorization component 602. This authorization component 602 determines if a user has authorization to write information onto the flash memory device. If the user does not have proper authorization, then the authorization component 602 denies a user request. If the user does have proper authorization, then the raw data 604 travels to the compression component 608 where there is application of a compression algorithm upon the data. The information travels to a writing component 610 that writes the information to a storage component 612.

In typical operation, the authorization component 602 functions off the host system, which can operate in conjunction with a network. In one embodiment of the subject specification, the authorization component 602 contains a list of authorizes host systems that can write to it. If a host system is not on the list, then it cannot write to the flash memory device 600. In another embodiment, only network users with a specific level of clearance can write to the flash memory device. The authorization component 602 can check with the network (e.g., compare the user name with a file stored on a network device) or it can have a file that the network updates each time the flash memory device 600 connects with the network.

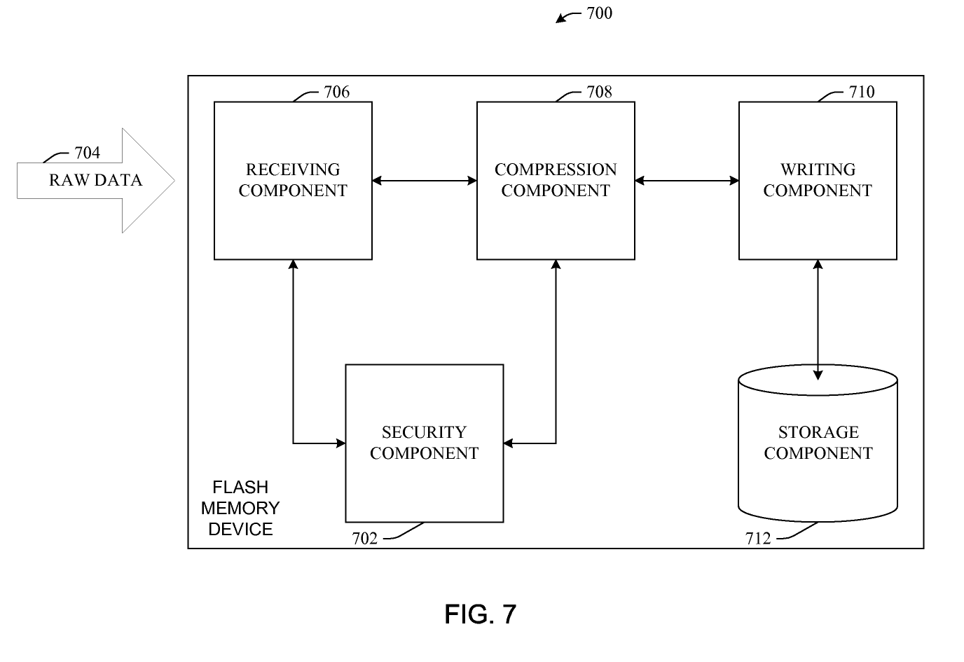

FIG. 7 illustrates an example flash memory device 700 implemented with a security component 702. Host system information 704 travels from a host system to a receiving component 706. The receiving component 706 communicates with a security component 702 to determine if the compression and writing can take place. The security component 702 requests the user on the host device for an authentication (e.g., a password). If the user does not provide a correct password, then the security component 702 denies a writing request. If the user does provide a correct password, the information travels to a compression component 708 for the application of a compression algorithm. Compressed information travels to a writing component 710 where the writing component writes the compressed information to a storage component 712.

In an alternative embodiment, host system information 704 passes through the security component 702 to arrive at the receiving component 706. The security component 702 functions as a block between the host system and the receiving component 706. The security component 702 holds a password that a user making a write request must provide in order to write to the storage component 712. If the user enters a successful password, then the information passes through to the receiving component 706. If the user enters an unsuccessful password, then the security component 702 rejects the information. While this description is for a single password, the security component 702 can have a password bank where any number of passwords allows access to the flash memory device. The security component 702 can also be configured with encryption technology that allows for greater protection.

In a further embodiment, the receiving component 706 receives both an authentication and raw data 704. The receiving component 706 sends the authentication to the security component 702 to compare the sent authentication to a set of stored acceptable authentications stored in the security component 702. The receiving component 706 attempts to send the request to the compression component 708. The compression component 708 does not accept the data until there is conformation from the security component 702 that there was a reception of an acceptable authentication. The receiving component 706 attempts to send the raw data 704 for a specific period. If there is no allowance from the security component 702 within the period, then the receiving component 706 rejects the data.

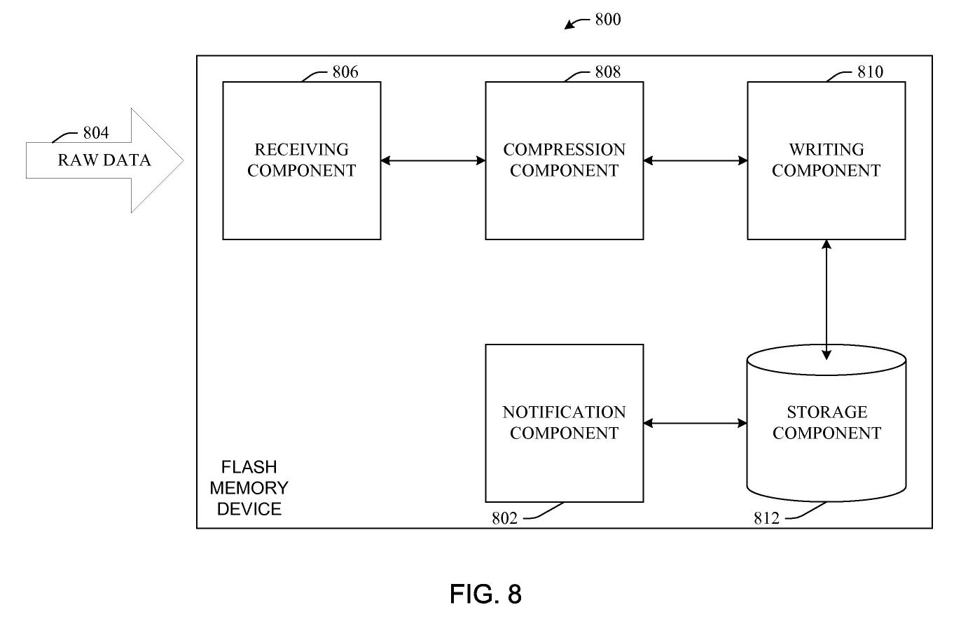

FIG. 8 illustrates an example flash memory device 800 implemented with a notification component 802. Host system data 804 travels from a host system to a receiving component 806. The receiving component 806 sends the data to a compression component 808 where there is an application of an appropriate compression algorithm. The compression component 808 transfers the newly compressed data to a writing component 810. The writing component writes the compressed data to a storage component 812. A notification component 802 sends a message containing information about the storage.

The notification component 802 can operate in numerous different embodiments. In one embodiment, the notification component 802 can contain wireless capabilities. For instance, the notification component 802 can send a notice that there has been a successful storage and compression, as well the compression format, to a cellular telephone that does not connect to a flash memory device 800. In another embodiment, the notification component 802 can send a notice back to the host system. In a further embodiment, the notification component 802 can send a notice back to a central network server where the server stores the notice, updates any appropriate files, and uses the notice information to formulate a report. It is possible for the receiving component 806 and notification component 802 to integrate into a single unit. In an alternate embodiment, the notification component 802 is a single color light emitting diode activates at the conclusion of a successful storage, which lets a user know that the storage is complete.

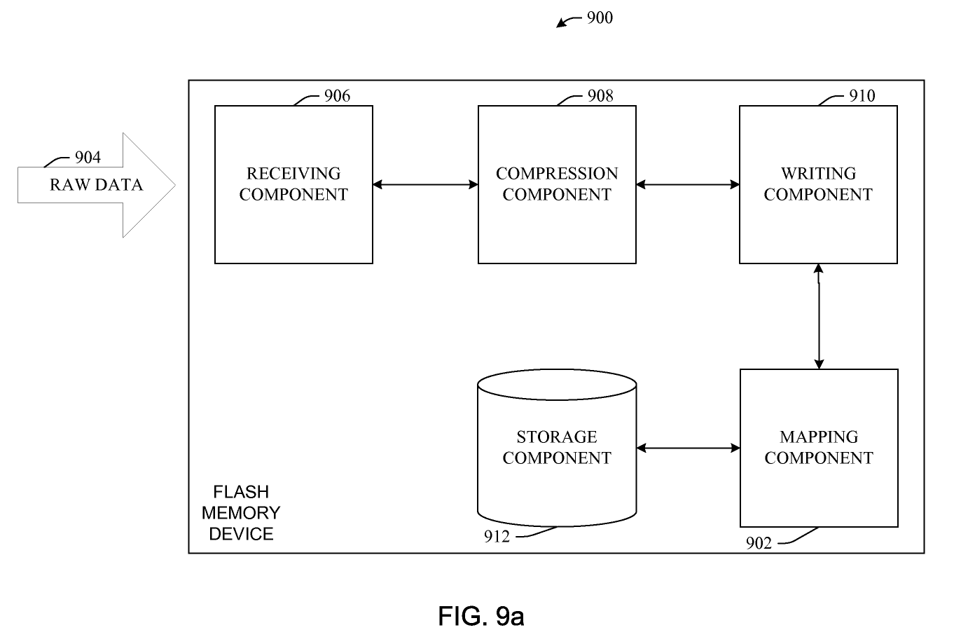

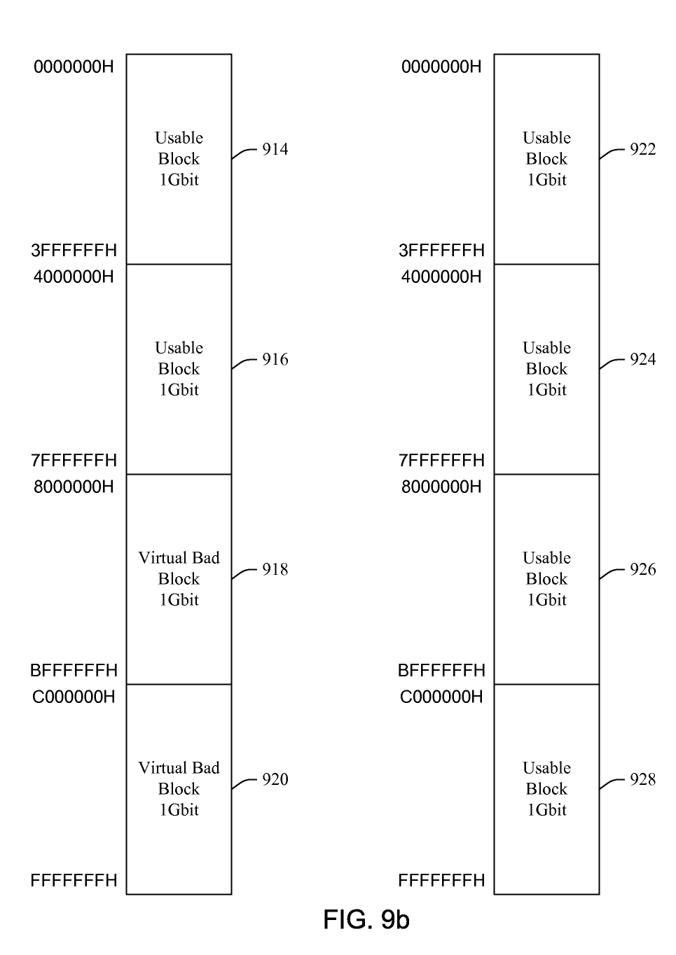

FIG. 9a illustrates an example flash memory device 900 implemented with a mapping component 902. A host system sends information 904 to a receiving component 906. The receiving component 906 transfers the information to a compression component 908 where an algorithm compresses the information 904. Compressed data travels to a writing component 910, which writes the compressed data to a storage component 912 (e.g., a memory array). The writing component 910 can have a registry that tracks of statistics for stored data.

For effective memory usage and management, host address mapping extends beyond the number of bits available to in a memory array. To allow for the most effective flash memory device 900, there is an addition of a mapping component 902, typically operating in conjunction with a writing component 910. For example, assuming there is a 50% compression, a 2 GB memory array can be initially mapped from a host side as a 4 GB address space. In the subject specification, a way to manage free space against occupies space is to use virtual bad blocks (e.g., memory blocks). Virtual bad blocks do not physically exist but are a logical representation. These blocks cannot store information but they can map to a good block; while a host does not use them initially, they are still addressable by the host. The registry can store a list of bad blocks and each time data is erased and new data is programmed, a bad block list can be updated and modulated based on an actual compression ratio (e.g., the ratio of raw data against compressed data).

A first mapping type is initial virtual bad block allocation. This allocation type functions when an initial host available address space is equal to a memory array space. As memory is added, this allows for previously bad blocks to convert into good blocks. For example, at 50% compression, the writing component writes 2 GB of data using 1 GB of a memory array. It is possible to unmark 1 GB of virtual bad blocks and make then good and usable. For a 4 GB memory array, 3 GB is still available so the total space addressable from the host system is 5 GB, 2 GB programmed and 3 GB free.

A second mapping type is dynamic virtual bad block allocation. This allocation type functions when an initial host available address space is greater than to a memory array space. In this allocation type, the flash memory device estimates an average data compression ratio. For example, if there is 60% average data compression, some virtual bad blocks are created and allocated in an available host address space to compensate the difference between an initial estimated average compression ratio (e.g., 50% compression) and an actual average data compression.

FIG. 9b illustrates an example block diagram of the implementation of the mapping component 902 of FIG. 9a using virtual bad blocks. Blocks 914 and 916 are initially available space in the storage component. These blocks are considered good blocks and initially these blocks are mapped. Blocks 918 and 920 represent initial virtual bad blocks. 922, 924, 926, and 928 represent a total amount of host space after virtual bad blocks 918 and 920 have been recovered. Recovery takes place due to successful data compression for information in the storage component 912.

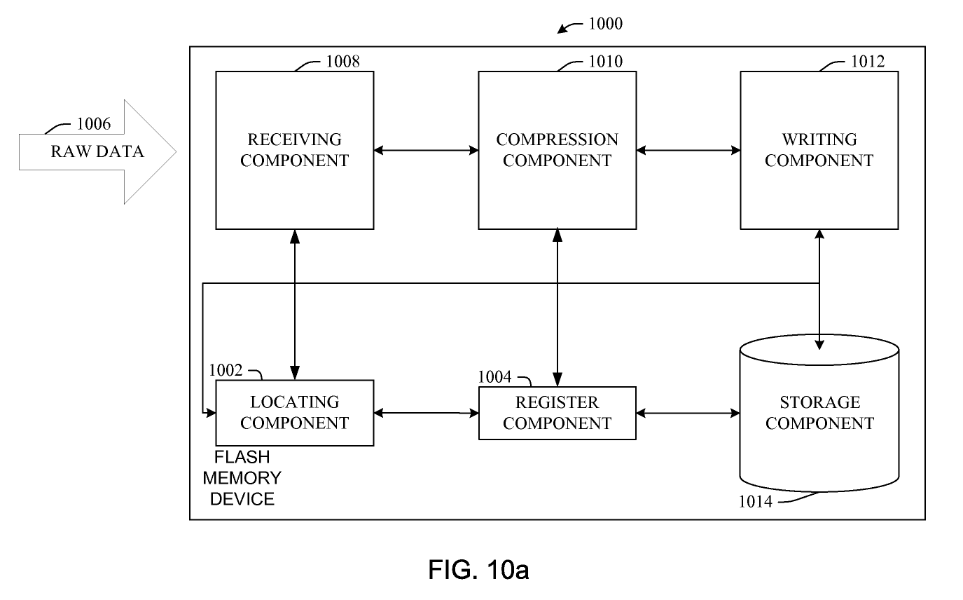

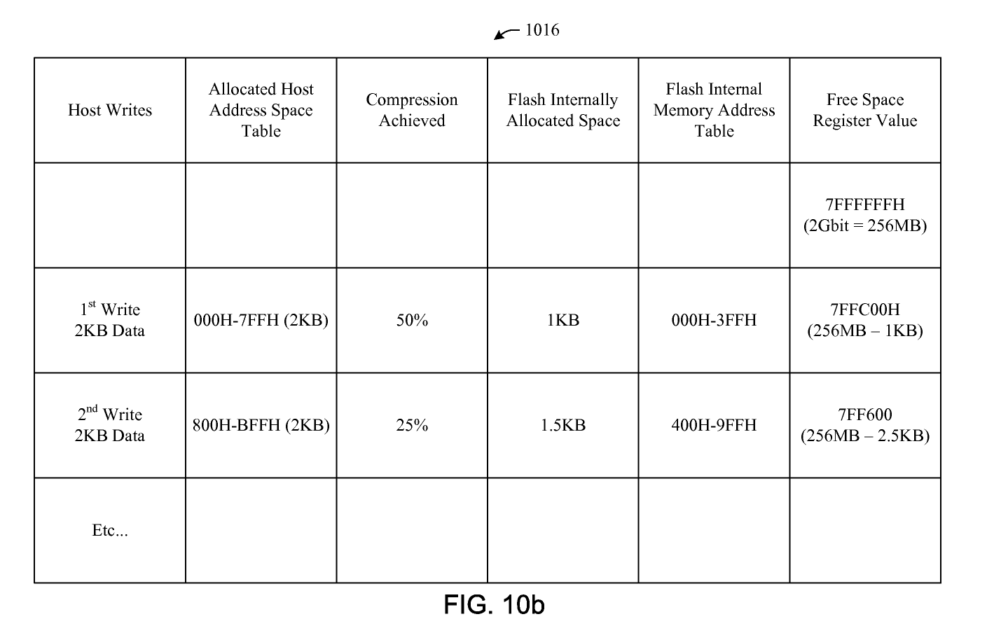

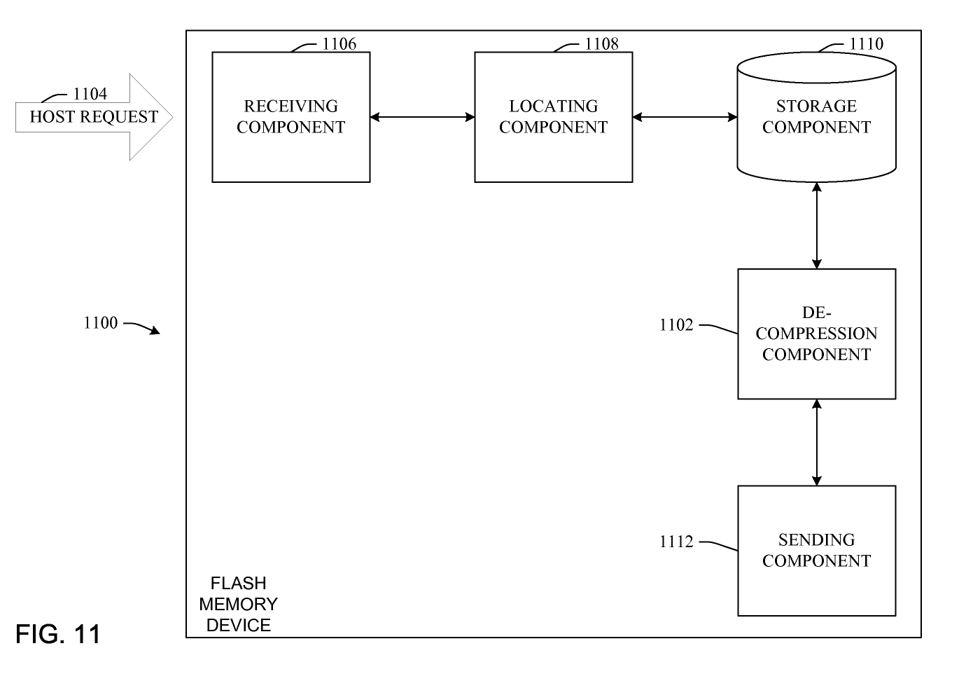

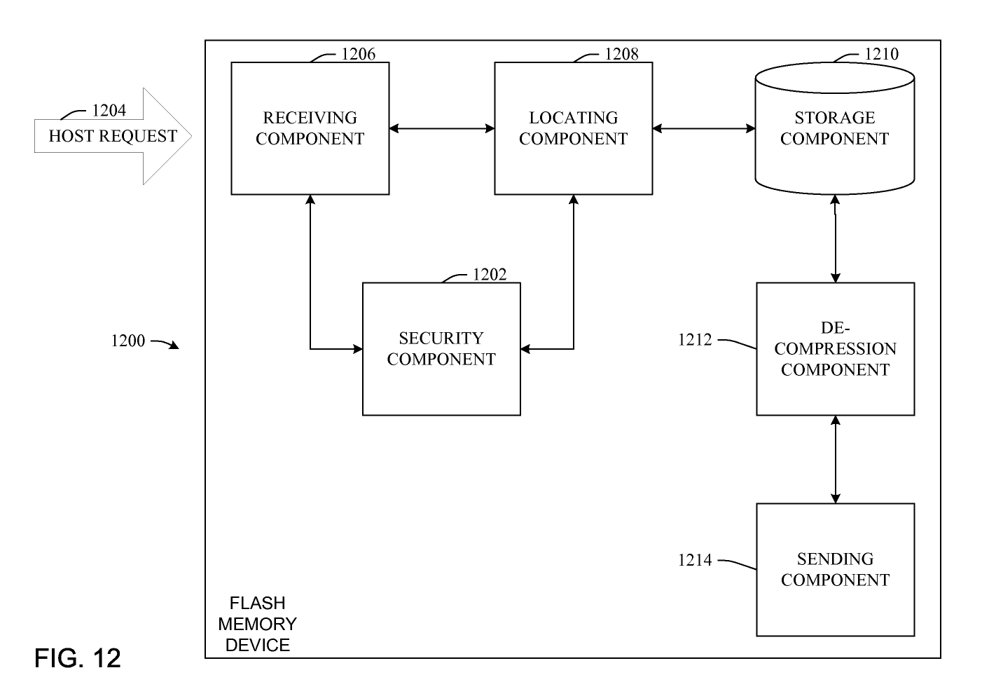

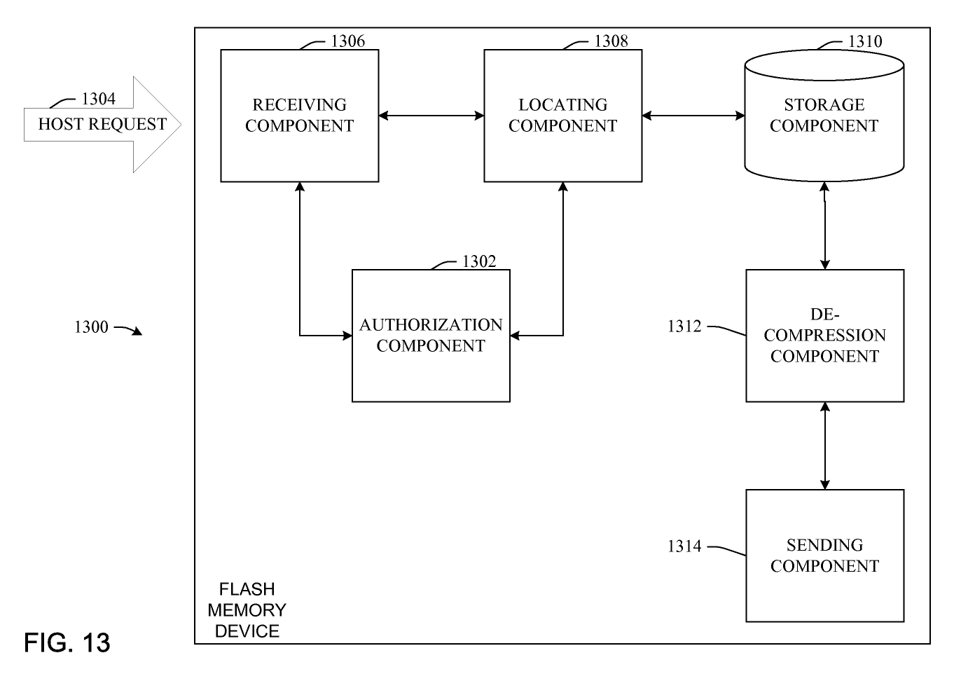

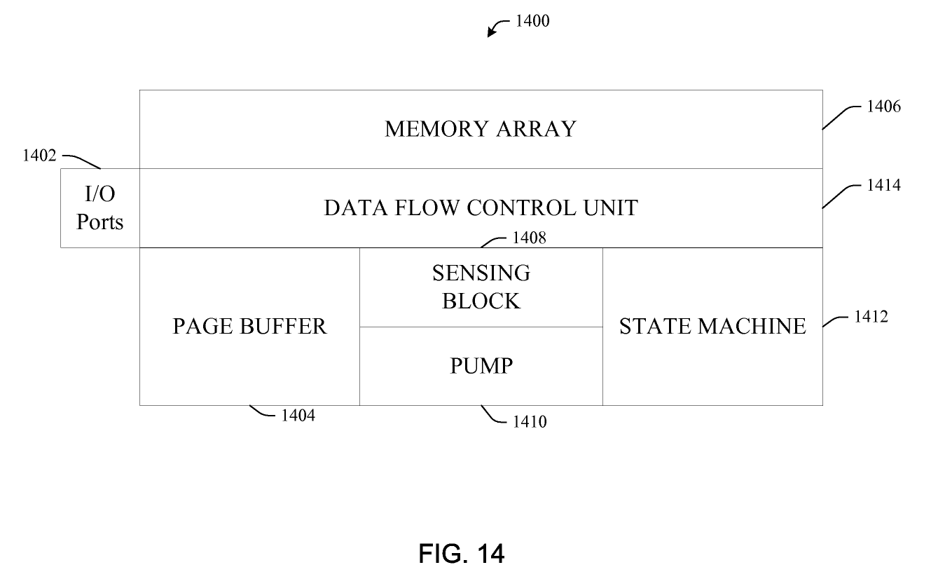

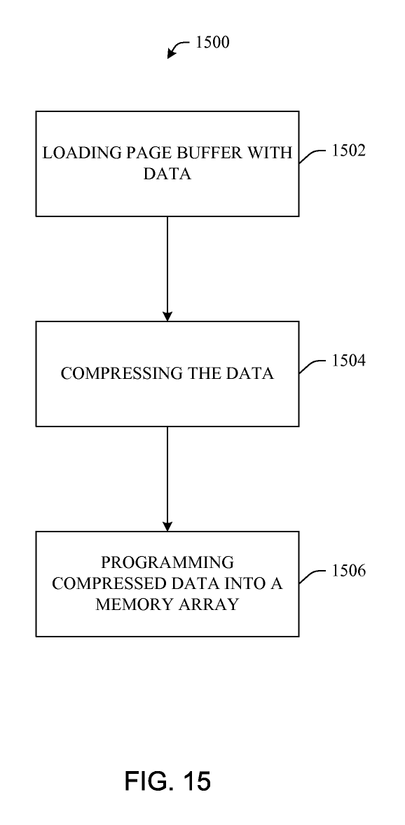

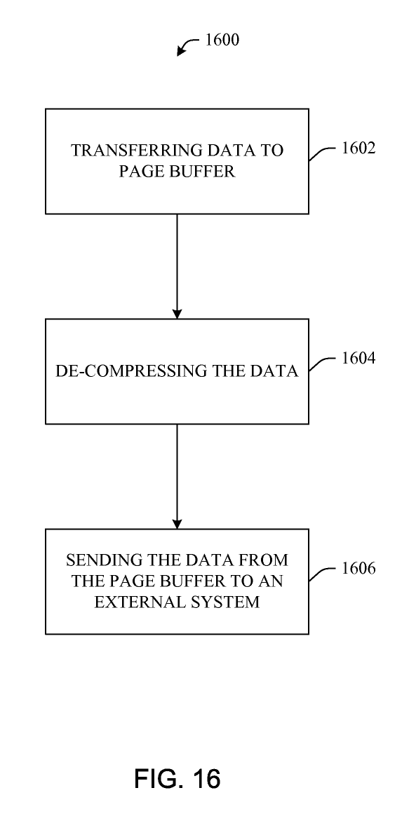

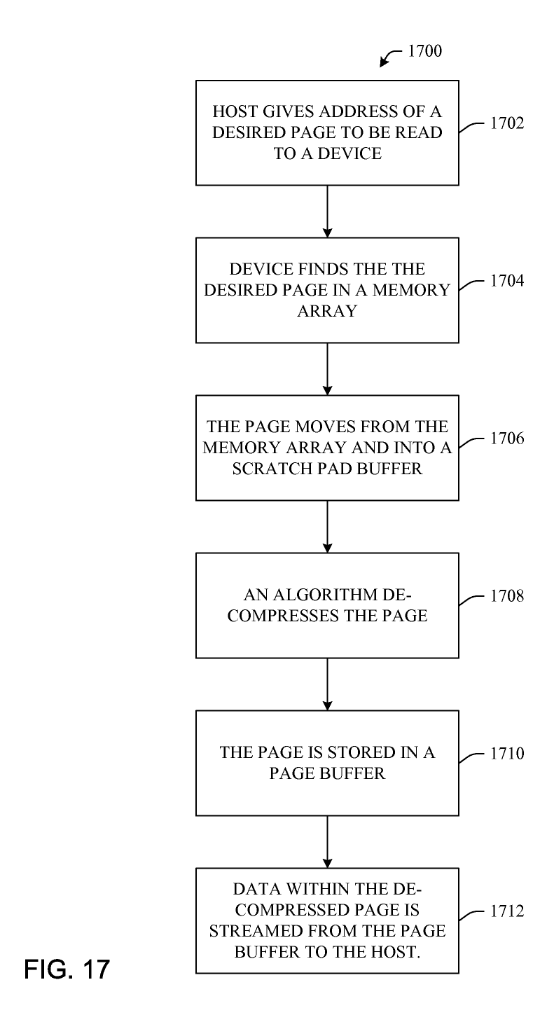

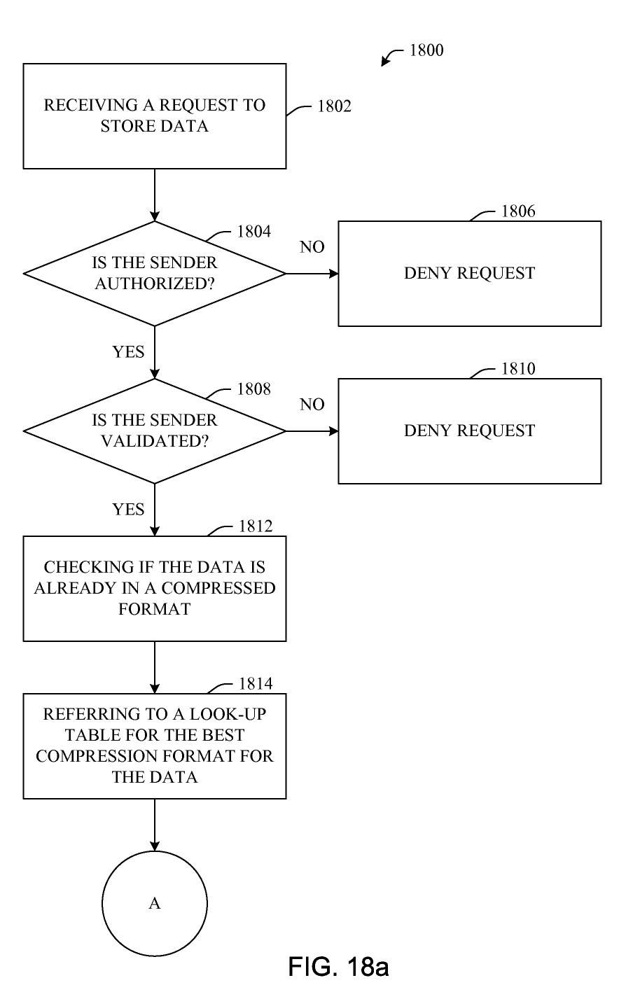

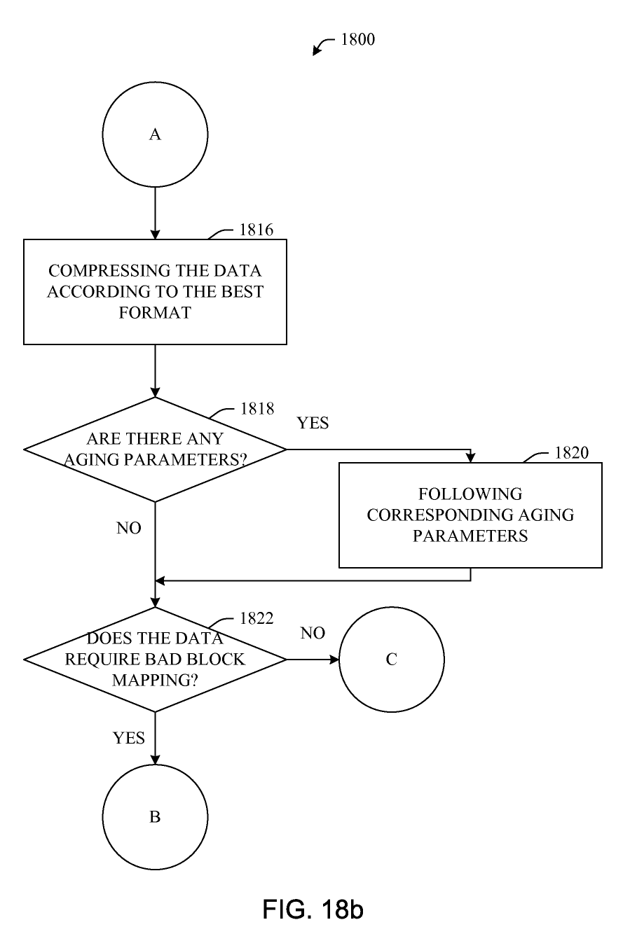

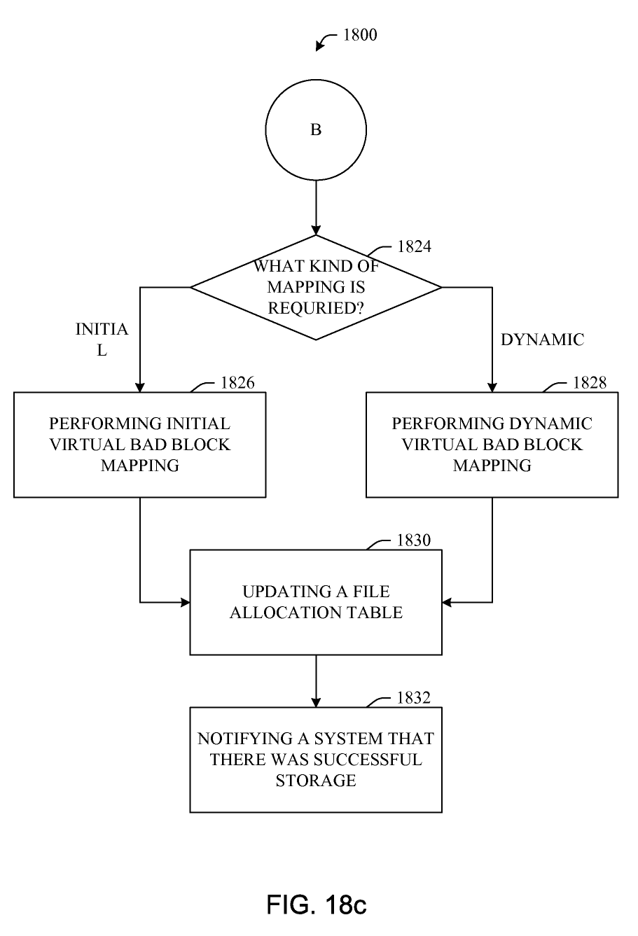

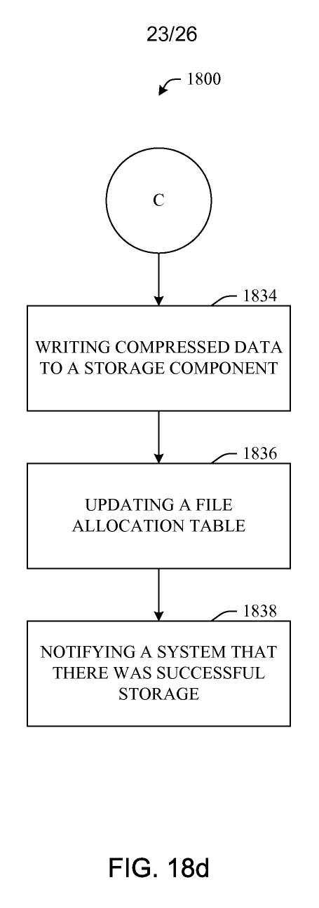

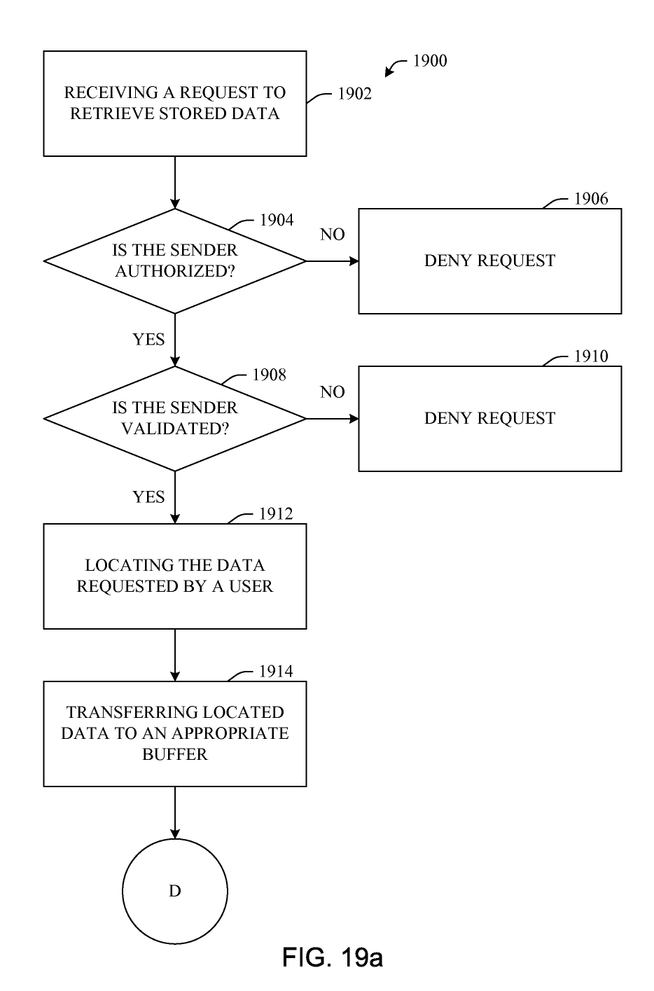

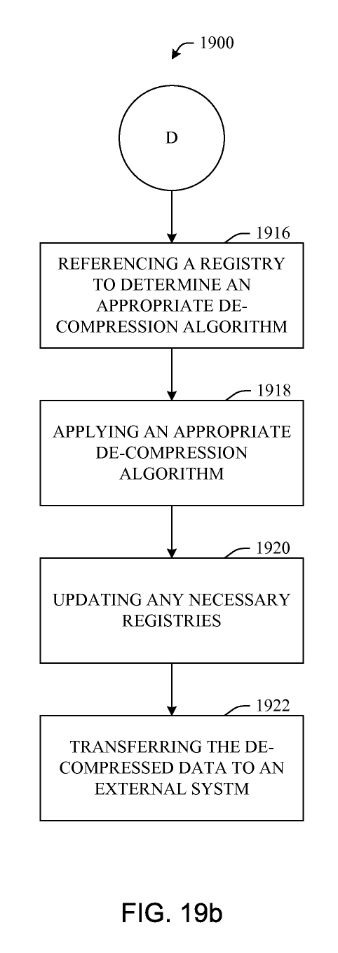

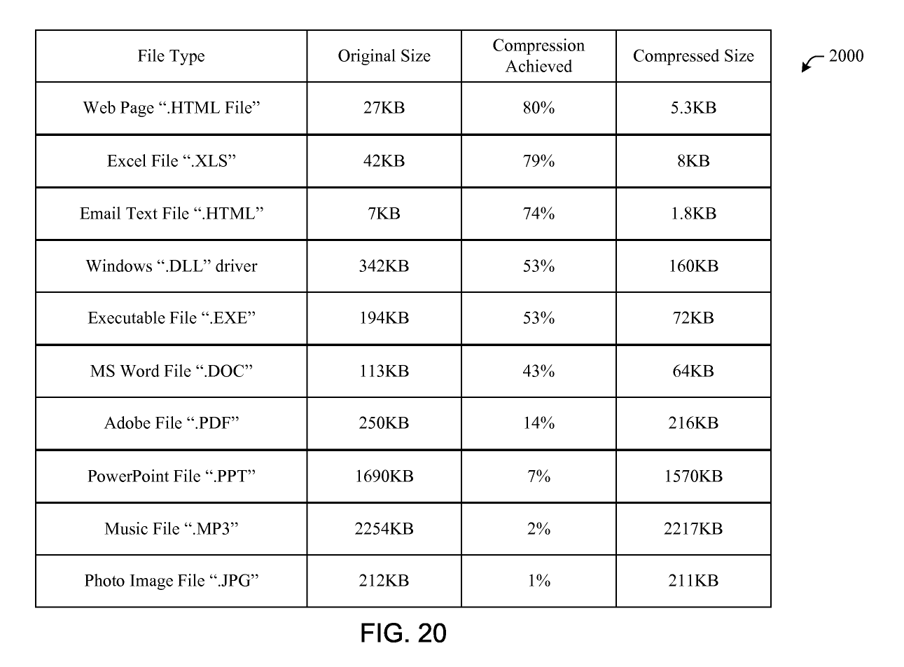

FIG. 10a illustrates an example flash memory device 1000 with a locating component 1002 in addition to a register component 1004. A host system sends a raw data 1006 to a receiving component. The receiving component 1008 transfers the raw data to a compression component 1010. The compression component 1010 attempts to compress the raw data 1006 typically based off a compression algorithm. A writing component 1012 writes compressed information to a storage component 1014. A register component 1004 communicates with the host system on how much memory is free in the storage component 1014. A locating component 1002 can keep track of host system address space and physical location of physical locations of compressed information in the storage component 1014. In addition, the locating component 1002 can link a host system address space with a physical location of compressed information in the storage component 1014.

FIG. 10b illustrates an example table 1016 utilized by the locating component 1002 of FIG. 10a. The first row lists the function of each column. The first column generates from the receiving component and it is the raw data that is to be written to the system. Each set of raw data has allocated host address space, which is shown in a second column. When a compression component operates to create compressed information, the amount of compression achieved is stored in a third column. A fourth column shows flash internally allocated space from the compression. The compressed information takes up in a storage component this amount of space. A fifth column contains the physical location of stored information. The register is updated and stored in a sixth column.

For example, in the third row, there is a first write of 2 kilobytes (2 KB) of raw data. The allocated host address space on the second column is 000H-7FFH, which addresses to 2 KB of storage. A compression of 50% changes the 2 KB down to 1 KB. The flash memory is addressed as 000H-3FFH. The amount of memory stored in a register component is lowered by 1 KB (256 MB-1KB). In the fourth row, a second write takes place of another 2 KB of raw data. This allocated host address space is 800H-BFFH, which addresses to 2 KB of storage. Here, the compression is only 25%, this requiring 1.5 KB to store new information. An internal flash memory location 400H-9FFH is selected and a register value lowers another 1.5 KB, which now totals a loss of 2.5 KB total. Pieces of 2 KB data that originate from a host device is tracked by a locating component through a table. Tracking can include logging a corresponding internal flash compression or an internal address space of a storage component where the information is physically located.

FIG. 11 illustrates an example flash memory device 1100 implemented with a de-compression component 1102. A host system sends a request 1104 for extraction of specific information from the flash memory device 1100. The request 1104 can be data. The host system can be any system capable of sending a request, including a cellular telephone or a personal digital assistant. In many instances, a user makes a request to the receiving component 1106. However, there can be other requests, for example, an automatic request by a host system or an automatic request by a network device on a network to which the flash memory device 1100 connects.

The receiving component 1106 sends the request to a locating component 1108 that finds the requested information in a storage component 1110. A receiving component 1106 can be any number of structures, including the USB port discussed for the receiving component 106 in FIG. 1. The receiving component 1106 can be integrated with a receiving component 106 in FIG. 1 (e.g., can both receive requests for storage and receive requests for extraction) or it can be an independent receiving component 1106 capable of only receiving extraction requests 1104. There can be other configurations as well, for example a configuration allowing the flash memory device 1100 to receive information about a connected network.

The locating component 1108 finds requested information in the storage component 1110 and can contain several features that allow for greater functionality. This locating component can be the same locating component as the locating component 1002 of FIG. 10. Features disclosed in either component can integrate together. Once possible feature contained within a locating component 1110 is a notification component. The notification component can send a message back to the host system or to another location that the locating component found the information or that the locating component could not find the requested information. Another possible component is an error-checking component. An error-checking component allows for a determination if the requested information has an error. For instance, if there was a corruption during storage, the error-checking component could report to the host system what kind of problem occurred. Another possible feature is a searching component. If compressed data was correctly stored, but placed in an incorrect location, a searching component can attempt to find misplaced data. The information leaves the storage component 1110 and travels to a de-compression component 1102, commonly though the locating component 1108 sending the information. The locating component 1108 can also copy the stored information, so only a copy travels to the de-compression component 1102 and the original compressed storage remains intact.

The de-compression component 1102 de-compresses the information that was previously stored in the storage component 1110. For this de-compression, the de-compression component 1102 extracts requested information from the storage component 1110. The de-compression component 1102 checks a registry that contains a name of a compression type that a system applied during compression. The de-compression component 1102 applies an appropriate de-compression algorithm to the stored information to return the information to its original format. Once de-compression occurs, all appropriate tables and registries are updated to account for the removal of data. The locating component 1002 of FIG. 10a can incorporate into the de-compression component 1102, wherein the de-compression component can contain all capabilities of a locating component. In addition, there can be integration with a register component and the de-compression component 1102. In another embodiment, the de-compression component 1102, a register component, and a locating component function as separate entities.

In an alternative embodiment of the subject specification, the de-compression component 1102 can de-compress stored information even if the flash memory device 1100 did not compress it. For example, a host system sends information in ‘.zip’ format, which is a compressed file type. A flash memory device 1100 can store the information without performing any compressing. When the flash memory device 1100 reads the stored information, the de-compression component 1102 can de-compress the information despite the fact that the flash memory device 1100 did not compress the information. There can be a look-up table that the de-compression component 1102 utilizes to find which de-compression algorithm to apply to standard compression formats. This embodiment can be particularly useful when a host system compresses data in a format and stores that information in a removable flash memory device 1100. If a receiving system does not have de-compression capabilities, then this information can still be read since the flash memory device 1100 has de-compression capabilities.

In another embodiment of the subject specification, the de-compression component 1102 can de-compress information that was partially compressed by a compression component as well as partially compressed by another source. For example, a host system sends a file that was in a compressed state, referred to as format ‘1’. The flash memory device 1100 performed a further compression on the file, referred to as format ‘2’. When the stored information is extracted from the storage component 1110, the information is de-compressed. This can take place in at least two ways. First, two separate algorithms run to de-compress the information, one for format ‘1’ and one for format ‘2’. The choice of which algorithms to run can be automated or can be made through a user interface provided to the host device from the flash memory device. Another way to de-compress the stored data is to have an algorithm capable of de-compressing both format ‘1’ and format ‘2’.

The de-compressed information travels to a sending component 1112 that sends information to an external system. This external system can be the host system that made an initial request or it can be another system. For example, a cellular telephone can request the extraction of information, and the sending component 1112 can send the de-compressed information to a network server through a wireless configuration. It is possible for the receiving component 1106 and sending component 1112 to integrate into a single unit.

There are two common instances where de-compression can take place. One instance is with a read command and one instance is with an erase command. When a common read command takes place, stored data does not move from the storage component 1110 to the de-compression component 1102. Instead, a data copy transfers from the storage component 1110 to the de-compression component 1102 while stored information remains intact. An erase command allows the locating component 1108 to both find stored data and to erase stored data. During an erase command (e.g., a request to extract stored data, which includes both a read and an erase), in one occurrence the information physically transfers to the de-compression component 1102 from the storage component 1110. In another occurrence, a copy is made of the data that travels to the de-compression component 1102 and an erase takes place of information on the storage component 1110. The read and erase commands are available for other de-compression components in the subject specification.

FIG. 12 illustrates an example flash memory device 1200 implemented with a security component. A host user sends a request 1204 to extract stored information from a flash memory device 1200. In one embodiment of the subject specification, the request travels to a receiving component 1206. The receiving component 1206 sends a request to a host system requesting an authentication (e.g., a password). Any received authentication is compared to allowable stored authentication. If there is a match between a sent and stored authentication, then the data passes to a locating component 1208. Once stored information is located in a storage component 1210, a de-compression component 1212 decompresses the information and a sending component 1214 sends the information to an external system. If there is not a match, then the request fails and the host system can attempt another entry.

In an alternative embodiment of the subject specification, a request from a host system travels to the security component 1202 prior to reaching the receiving component 1206. The request does not proceed to the receiving component until the security component 12102 receives a valid authentication. Once the security component 1202 receives a proper authentication, the security component 1202 allows information to pass to a locating component 1208.

In a further embodiment, the receiving component 1206 receives both a password and a request. The receiving component 1206 sends the password to the security component 1202 to compare the send password to acceptable passwords stored in the security component 1202. The receiving component 1206 attempts to send the request to the locating component 1208. The locating component 1208 does not accept the request until there is conformation from the security component 1202 that an acceptable password was sent. The receiving component 1206 attempts to send the request for a specific period. If there is no allowance from the security component 1202 within the period, then the receiving component 1206 rejects the request.

FIG. 13 illustrates an example flash memory device 1300 implemented with an authorization component 1302. A host system sends a request 1304 to read stored data from a flash memory device 1300. In one embodiment of the subject specification, the request travels to a receiving component 1306. The receiving component 1306 performs a check to a host system determining if a requester has authorization to make a read from the storage component. The requester can be a number of identifiers, including a user name (e.g., Jane_Doe) or a host system Internet Protocol (IP) address. Received requests are compared to allowable stored request information. If there is a match between a sent and stored authentication (e.g., Jane_Doe is an allowable name for reading from the flash memory device), then the request passes to a locating component 1308. The locating component 1308 located information in a storage component 1310. This information is de-compressed by a de-compression component 1312 and sent to an external system via a sending component 1314. If there is not a match, then the request does not continue and the host system can attempt successive entries.

In another embodiment of the subject specification, a host system request 1304 travels to the authorization component 1302 before reaching the receiving component 1306. The host system request 1304 does not continue to the receiving component 1306 until the authorization component 1302 determines a valid authentication from the host system. Once the authorization component 1302 determines a proper authentication (e.g., the authorization component determines a name sending the request is on an approved list), the authorization component 1302 allows information to pass to a locating component 1308.

In an additional embodiment, the receiving component 1306 receives both a password and a request 1304. The receiving component 1306 sends the password to the authorization component 1302 to compare the send password to acceptable passwords stored in the authorization component 1302. The receiving component 1306 attempts to send the request to the locating component 1308. The locating component 1308 does not accept the request until there is conformation from the authorization component 1302 that an acceptable password was sent. The receiving component 1306 attempts to send the request for a specific period. If there is no allowance from the authorization component 1302 within the period, then the receiving component 1306 rejects the request.

FIG. 14 illustrates an example flash memory device 1400 with functional components. A typical flash memory device 1400 has I/O ports 1402 that connect to a host system. The I/O port 1402 communicates with the host system digitally, meaning an I (e.g., high) or an O (e.g., low) represent all data. This I/O port 1402 can have a configuration of a USB port or other configurations, for example individual metal prongs. In addition, the I/O port 1402 can contain several components of the subject specification, for example a sending component and a notification component. Another function of the port 1402 is that it can provide power to the flash memory device.

A page buffer 1404 is a temporary holding place for information. The page buffer 1404 functions during the mapping of the information when retrieved from storage. A common page buffer 1404 employs static random access memory (SRAM). In many flash memory devices 1400, there is more then one page buffer 1404. A memory array 1406 is the storage location for a flash memory device 1400, and this is the common location of a storage component. Typically, a memory array 1406 comprises a number of individual cells that can contain information in bits, with typical cells holding one to four bits for information. There can be a scratch-pad buffer 1404 that performs temporary storage and FIG. 14 shows this scratch pad buffer 1404 integrated in the general page buffer 1404.

A sensing block 1408 functions to monitor overall operations within the flash memory device 1400. For example, a sensing block 1408 can determine is a page buffer 1404 is free before a component sends information to that specific page buffer 1404. A pump 1410 provides a high voltage for operations that require such a voltage. For example, some erasing functions require a relatively high level of voltage for proper operation. A state machine 1412 provides logic functions to the flash memory device 1400. For example, some components only run during certain states. While the state machine 1412 provides a high state, some components are on while others are off and visa vice versa for a low state.

A data flow control unit 1414 controls most major functions of the flash memory device 1400. These functions generally includes writes, reads and erases, as well as several of the functions performed by components of the subject specification. For example, a compression component, including all stored algorithms and registries can be located in the data flow control unit 1414. A data compression engine can store compression information and capabilities. This engine can be integrated into the data flow control 1414 unit or be a stand along unit. In addition, other components can exist in the data flow control unit 1414, including a de-compression component, a mapping component, a security component, and an authorization component.

FIG. 15 is an example methodology 1500 of storing data in a compressed format on a flash memory device. The flash memory device loads data info a page buffer 1502, for example, the data enters a SRAM memory buffer. While the subject specification commonly refers to a page buffer, a plurality of page buffers can function in the place of a single page buffer. In general, the greater the size of the raw data, the large number of page buffers used. For example, if a page buffer is 4 Kilobytes (KB), and a file entering the flash memory device is 12 KB, the methodology employs three flash buffers to process the data.

Event 1504 is compressing raw data. Performance of compression occurs within a flash memory device, usually while the data remains in the page buffer. This is commonly performed through the application of a compression algorithm, which is often a loss-less compression algorithm. The application of the compression algorithm takes place regardless if the raw data entered the flash memory device in a compressed format. In one embodiment, a look-up table functions to allow for an application of an optimal compression algorithm depending on the state of loaded raw data.

Act 1506 is programming compressed data into a memory array. Typically, a writing component places the information into a storage component. Often, in addition to writing information, the writing component updates a registry that allows the flash memory device to know the compression format and compression characteristics of stored data. This registry can match a host logical address with an internal physical address. A common implementation of this matching is using software that runs a file allocation table.

FIG. 16 is an example methodology 1600 of de-compressing data within a flash memory device. Stored information travels from a storage location to a page or scratch buffer 1602. As with the previous methodology, while the subject specification commonly discusses a single page buffer, a plurality of page buffers can substitute for a single page buffer depending on the memory size. Two common instances operate in conjunction with action 1602. In on instance, there is a read command in which the stored information is determined, but it remains in tact. In one embodiment, only a copy of the data transfers to the page buffer 1602. In another instance, there is an erase command accompanied with the read command. This can directly transfer data to a page buffer or transfer a copy of data as well as erase information from a storage component. De-compression of data in a page buffer occurs 1604. This is commonly done through a de-compression algorithm. In most cases, the de-compression algorithm returns the data to its original format. This is because most algorithms run a loss-less compression format; however, this methodology can be practiced with other compression formats, for example lossy compression. This methodology demonstrates that the de-compression and sending can take place on the same page buffer, though in other embodiments multiple page buffers can function as this single buffer does. This includes buffers that are of two different types.

The data travels from the page buffer to an external system at action 1606. The external system can be the requesting system or it can be a completely different system. In one embodiment of the subject specification, the de-compressed data travels through the host device and to an intended network device remotely connected to the host device. For example, a host cellular telephone can request that a de-compressed music file be sent to another cellular telephone. The music file is de-compressed and the flash memory device sends the de-compressed music file across a wireless transmission the intended cellular telephone.

FIG. 17 is an example methodology 1700 of communicating compressed data to a host system in a de-compressed format. A host system gives a flash memory device the address of a page to be read 1702. One example is a user on a personal digital assistant making a request for a specific file, for example an audio file. The personal digital assistant converts the command into an appropriate request that contains the address.

The flash memory device finds the desired page in a memory array 1704. This is commonly done by matching an external host page address with an internal address inside the flash memory device. The host page address originates from the host device, in the above example a personal digital assistant. The internal address is located in a file allocation table or a reference table. This internal address was stored in the table during the compression phase.

The page transfers from the memory array to a scratch pad buffer 1706. This buffer functions as a temporary location for the compressed information. This can be either from a read command or from an erase command. There is application of a de-compression algorithm 1708. The selection of the algorithm originates from information stored in the reference table. When a compression takes place, the correct algorithm to de-compress the stored information is stored in a reference table. A de-compression component applies the appropriate de-compression algorithm. A page buffer stores the de-compressed information 1710. In normal operation, this page buffer is a SRAM page buffer. The data streams from the page buffer to a host system 1712. In many cases, the final destination of the stored information is a host device (e.g., a personal digital assistant).

FIG. 18a-FIG. 18d is an example methodology 1800 of writing data to a flash memory device. A flash memory device receives a request to store data into a flash memory device, which originates from a host device 1802. There is performance of a check to determine if the request originates from an authorized source 1804. This is commonly done through an authorization component. An example of this authorization is if a user can provide a password that the flash memory device recognizes as allowable. If the user cannot provide an appropriate password, then there is a denial of the request 1806. Though not shown, the denial can loop back to ask a user if they would like another attempt at entering an appropriate password. If the user provides a correct password, then the methodology continues.

The methodology also checks if the request originates from a validated source 1808. A security component can perform this check. For example, in an automated request from a host device, the flash memory device can have a list of acceptable Internet Protocol addresses from which to receive information. If the source does not have an acceptable address, then there is a denial of the request 1810. Though not shown, the denial can loop back to ask for another validation. While less appropriate in an example with Internet Protocol addresses, this can be appropriate when there is a non-automated request generating from a host device utilizing a user name. In an alternative embodiment, events 1804 and 1808 can combine to ask a user for a user name and a password in a same substantiating action, in a substantiation component. This substantiation component combines the features of a security component and an authorization component.

At action 1812 there is a check determining if the data is already in a compressed formation. A compression-checking component can complete this check. Raw data can enter a flash memory device in a compressed format, for example in ‘.zip’ format. This check can both perform a yes/no type check to determine if the data is compressed, or perform a complete check to determine the compression type and possibly even the original amount of data. The methodology engages act 1814 that refers to a look-up table to determine which compression format is optimal. This is usually done by an optimization component. If the data enters is in the compressed format then there can be a specific compression algorithm that can optimize the compression of the data.

There is compression of the data 1816, usually performed by a compression component. An application of a compression algorithm performs the compression. The corresponding compression type in the look-up table usually determines this compression algorithm. In many cases, the data is located in a page buffer when the compression takes place. A check occurs as to any aging parameters regarding information writing 1818. Typical aging parameters are located on an aging component, which typically has both an AI component and a polling component. An aging parameter check allows a system to maximize storage efficiency. For example, if a memory array is full, the aging component can approve the deletion of stored material that has not been accessed since a specific period (e.g., 18 months). If there are corresponding parameters, then they are followed 1820.

Regardless if there are aging parameters or not, the methodology checks if there is any required bad block mapping 1822. If mapping is required, then the flash memory device must determine which type of mapping must take place 1824. In many applications, the choice of mapping type is between initial bad block mapping or dynamic bad block mapping. This choice is usually dependent on the difference between a host available address space and an internal memory array space. Whichever mapping is appropriate, a mapping component will commonly perform any necessary mapping 1826, 1828. The mapping component works in conjunction with a writing component in storing information.

Regardless of the mapping type required, there is an updating of a file allocation table 1830. Since there was mapping, the file allocation table is updated with the current arrangement of bad blocks. Other information is also updated into the file allocation table, which can be done by numerous components, for example a writing component. Other information commonly included in a file allocation table update is which kind of compression format applies to the stored information and how much memory does the file storage occupy. A final notice can travel to an external system that the overall operation is complete 1832. This external system can be the same as the host system or it can be another system. For example, the flash memory device can have a wireless communication capability in a notification component that notices a cellular phone wirelessly.

If mapping is not required, then there is storing of compressed information 1834. This is usually done by a writing component and a write is typically done into a storage component (e.g., a memory array). Once there is a successful write, there is an update of a file allocation table 1836. This is similar to the update of action 1830. One important difference between 1830 and 1836 is that the update does not include information on mapping since no mapping occurred. However, there is usually an update regarding the compression type for the stored information. A system notification takes place 1838 similar to the event 1832.

FIG. 19a-FIG. 19b is an example methodology 1900 of processing a request for reading stored compressed data. A flash memory device receives a request to retrieve stored data 1902. This request commonly originates from a host device, for example a cellular telephone or a personal digital assistant. This request can be merely to read data or it can also request for erasing data. There is a test to establish if the request originates source that can make such a request, which commonly operates from an authorization component 1904. An example of this authorization is if a user can provide a thumbprint scan that the flash memory device recognizes as allowable. If an inputted thumbprint does not match an allowable thumbprint, the flash memory device has on record, then the flash memory device denials the request 1906. Though not shown, the denial can loop back to ask a user to attempt inputting an authorized thumbprint again. This loop back can be caped at a certain number of times or it can function as a continuous loop. If the user provides a correct thumbprint, then the methodology continues.

The methodology also verifies if the request originates from a validated system 1908, typically done by a security component. For example, a user of a host system can enter a specific user name (e.g., John Doe). If the name provided by a user does not match an approved name in the flash memory device, then a security component denies the request 1910. Though not shown, the denial can loop back and ask for another name. Similar to step 1904, this can be a continuous loop back or the loop back can have a capped number of cycles. In an alternative embodiment, events 1904 and 1908 can combine into a singular event to ask a host system for a user name and a thumbprint.

Action 1912 locates the specific data from the request. Commonly, a locating component locates this data. This act can also include troubleshooting actions that allow for greater flexibility in located the requested data. For example, the stored data can have been accidentally stored in the incorrect location, so it is not located where it should be located. A troubleshooting function can run that attempts to locate the misplaced data. Once the data is located, the stored data travels to an appropriate buffer 1914. A common buffer used in this operation is a scratch-pad buffer. The data sent to the scratch pad buffer could be the stored information (e.g., extraction) or it could be a copy of the stored information, thus leaving the memory array intact (e.g., a read).

There is a referencing of a registry (e.g., fact allocation table) that has information about the compressed data 1916. One important piece of data that is referenced is the compression type applied to the compressed data 1918. This allows for a proper application of a de-compression algorithm. Acts 1916 and 1918 can work in conjunction. For example, the registry can contain the compressed data size as well as what size the data should be in a de-compressed format. Once the de-compression algorithm completes, it can check the final size with the size stored in the registry. If there is not an exact match or if there is not a match within a pre-determined number of percentage points, then error-checking actions can take place.

1920 is the act of updating any registries. There are numerous updates that can take place, based on the different types of information the registry holds. One example of an update is to delete information about the stored data if the data was read and not copied (e.g., the compression type). Another update is any adjustment of available memory allocation due to the extraction of the stored memory. The de-compressed information transfers to an external system 1922. This can be done through the same location that received the request or this can be done through an alternative means, for example wireless communication.

In one embodiment of the subject specification, there is reception of a reading request 1902. At sometime before the de-compression, a user removes the flash memory device from the host system, causing the flash memory device to lose power. However, the flash memory device can store the request and file at what step in the methodology the system lost power, and when power is resumed, the methodology continues where is stopped. In another embodiment of the subject specification, the request for reading the data is to read the data to another device. If this takes place, then the flash memory device can retain the request until the device is connected to the requested device.

FIG. 20 illustrates an example result table 2000 of common compression formats. It is to be understood that results shown have come through experiment (e.g., compressing test files). Actual results of a full implementation can vary. The table discloses a variety of file types and appropriate compressions of the file types using aspects disclosed in the subject specification.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flash memory, comprising:
a compression component that compresses data; and
a writing component that writes the compressed data to a storage component within flash memory.

2. The flash memory of claim 1, further comprising a register component that tracks data written to the storage component.

3. The flash memory of claim 1, further comprising a de-compression component that de-compresses compressed data stored in the storage component.

4. The flash memory of claim 1, further comprising a mapping component that maps memory blocks in the storage component for writing compressed data.

5. The flash memory of claim 4, wherein the mapping component uses virtual bad blocks to map memory blocks.

6. The flash memory of claim 1, further comprising a compression check component that determines if data is compressed prior to operation of the compression check component.

7. The flash memory of claim 1, further comprising an optimization component that determines an algorithm for obtaining a highest compression ratio for compressed data.

8. The flash memory of claim 1, further comprising an authorization component that checks if a host system is allowed to enter data into flash memory.

9. The flash memory of claim 1, further comprising a security component that checks authorization information entered from a host system to allow data input into flash memory.

10. The flash memory of claim 1, further comprising an aging component that removes data from the storage component to allow for writing of new compressed data.

11. The flash memory of claim 10, wherein the aging component further comprises an artificial intelligent component that makes inferences as to which data to remove, and when to remove the data.

12. The flash memory of claim 10, wherein the aging component further comprises a policy component that selects data removal based on a set of policies.

13. The flash memory of claim 1, further comprising a notification component that transmits a notification when compressed data is written to the storage component.

14. The flash memory of claim 1, further comprising a locating component that locates compressed data in the storage component.

15. A method of flash memory storage, comprising:
compressing data; and
writing the compressed data to a storage component within a flash memory.

16. The method of claim 15, further comprising de-compressing data stored in the storage component.

17. The method of claim 15, further comprising mapping data into respective memory blocks of the storage component.

18. The method of claim 15, further comprising updating a reference location with storage component information.

19. The method of claim 15, further comprising substantiating that a host device can send data to the flash memory.

20. A flash memory, comprising:
means for compressing data;
means for storing compressed data within flash memory; and
means for de-compressing compressed data stored within flash memory.
